(19) United States
(12) Patent Application Publication
(10) Pub. No.: US 2016/0276861 A1
(43) Pub. Date: Sep. 22, 2016

(54) MOBILE ELECTRONIC DEVICE PROTECTIVE CASE WITH INTEGRATED INDUCTIVE CHARGING REPEATER

(71) Applicant: A.G. Findings & Mfg. Co., Sunrise, FL (US)

(72) Inventor: Fernando TAGES, Coral Springs, FL (US)

(21) Appl. No.: 14/659,952

(22) Filed: Mar. 17, 2015

(51) Int. Cl. H02J 7/02; H02J 7/00; H02J 7/04

(52) U.S. Cl. CPC H02J 7/025; H02J 7/04; H02J 7/0042; H02J 2007/0096

(57) ABSTRACT

A mobile electronic device case includes a housing sized to releasably retain a mobile electronic device an inductive charging signal repeater disposed within the housing.

### CROSS-REFERENCE TO RELATED APPLICATION

n/a

### STATEMENT REGARDING FEDERALLY SPONSORED RESEARCH OR DEVELOPMENT

n/a

### FIELD

The present invention relates to mobile electronic device cases, and more particularly, mobile electronic device cases with an inductive charging signal repeater.

### BACKGROUND

Many smartphones, tablets, and other portable electronic devices include a rechargeable battery configured to be charged through inductive charging. In particular, inductive charging pads have been devised such that placement of a portable electronic device in contact with the inductive charging pad wirelessly charges the battery of the portable electronic device, thereby eliminating the need to physically tether the portable device to a with a power cord.

Many portable electronic device manufactures have adopted the Qi inductive power standard, which includes a power transmission pad and a compatible receiver in the portable electronic device. To use the system, the mobile electronic device is placed on top of the power transmission pad, which charges the mobile electronic via resonant inductive coupling up to a predetermined distance. For example, the Qi standard provides that the inductive charging signal received in the corresponding portable electronic device must be within a maximum distance of 5 mm from the inductive charging signal transmitter in order for the battery of the portable device to be charged.

Owing to the requirement that portable electronic devices be placed in close proximity to the inductive charging signal transmitter on the charging pad, users desiring to charge their portable electronic device are often forced to remove their electronic devices from any protective case that may be retaining the electronic device. Moreover, owing to the thickness and material composition of some mobile electronic device cases, the cases themselves can attenuate the transmitted inductive charging signal so that even when the mobile electronic device is within the required 5 mm distance, the mobile electronic device fails to be charged inductively.

### SUMMARY

The present invention advantageously provides for mobile device cases with an inductive charging signal repeater. The mobile electronic device case includes a housing sized to releasably retain a mobile electronic device an inductive charging signal repeater disposed within the housing.

In another embodiment, the mobile electronic device case includes a housing sized to releasably retain a mobile electronic device an inductive charging signal repeater releasably engageable to a portion of the housing.

In yet another embodiment the mobile electronic device case includes a housing sized to releasably retain a mobile electronic device. The housing includes a back portion. A passive inductive charging signal repeater is molded within the back portion of the housing, the inductive charging signal repeater being entirely concealed within the back portion and configured to charge the mobile electronic device when the housing is placed in contact with an inductive charging device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a disassembled view of a mobile electronic device case constructed in accordance with the principles of the present invention;

FIG. 2 is a view of a slice through the mobile electronic device case shown in FIG. 1 with the stippling at top of case shown in FIG. 1 removed;

FIG. 3 is a cross-sectional view through A-A of a first portion of the mobile electronic device case shown in FIG. 2 with an inductive charging pad beneath the first portion;

FIG. 4 is a schematic diagram of a passive inductive charging signal repeater constructed in accordance of the principles of the present invention;

FIG. 5 is a schematic diagram of an active inductive charging signal repeater constructed in accordance of the principles of the present invention;

FIG. 6 is a schematic diagram of an active inductive charging signal repeater configured to generate its own inductive charging signal; and

FIG. 7 is the view of FIG. 3 with a charging indicator on the first portion.

### DETAILED DESCRIPTION

As used here, relational terms, such as “first” and “second,” “top” and “bottom,” “front and rear,” and the like, may be used solely to distinguish one entity or element from another entity or element without necessarily requiring or implying any physical or logical relationship or order between such entities or elements.

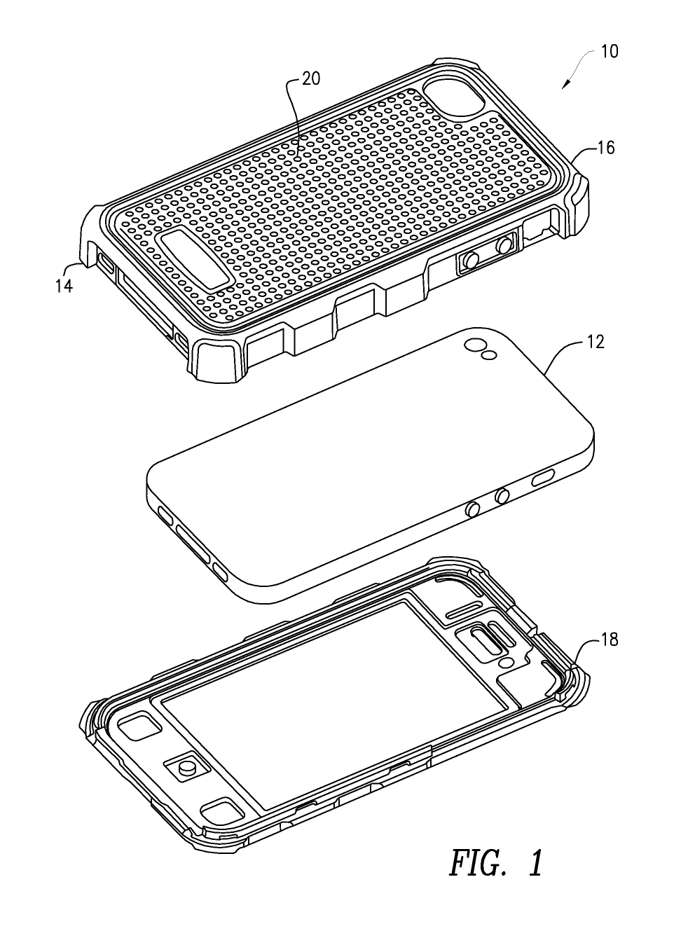

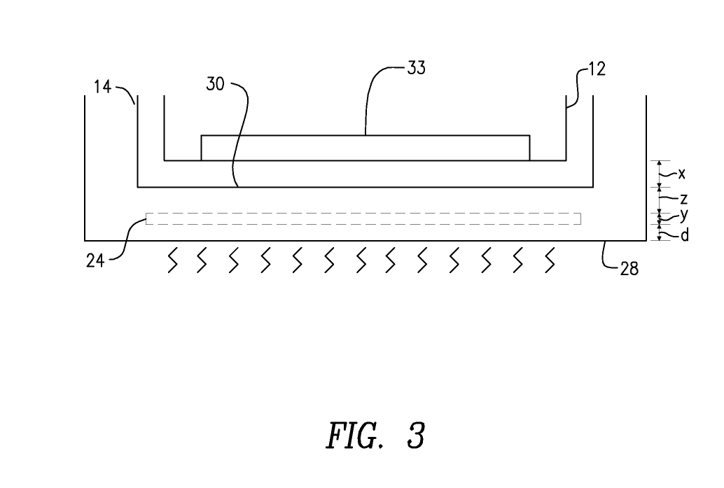

Now referring to drawings in which like reference designators refer to like elements, there is shown in FIG. 1 an exemplary mobile electronic device case constructed in accordance with the principles of the present invention and designated generally as “10.” The mobile electronic device case 10 is sized to receive and releasably retain an electronic mobile device 12 such as a smartphone, tablet, laptop, and the like. The case 10 may include a housing 14 which is configured and sized to releasably retain the mobile electronic device 12. The housing 14 may be any shape or size and may include protective resilient materials such as thermoplastic polyurethane, or rigid materials such as polycarbonate, or a molded combination of each. The housing 14 may be unitary in construction with an opening sized to receive the mobile electronic case 12, or may include a one or more portions releasably engageable with each other to retain a particular mobile electronic device 12 within. For example, the housing 14 may include a first portion 16, such as a base, that is releasably engageable with a second portion 18, such as a cover, to at least substantially surround and retain the mobile electronic device 12 within. In either the unitary or multi-piece configurations, the housing 14 includes a substantially planar back portion 20 configured to contour the back portion of a corresponding mobile electronic device 12 retained within. In particular, the back portion 20 of the housing 14 is disposed on the face of the housing 14 opposite the side of a screen portion 22 (seen in FIG. 3) of the mobile electronic device 12 when the mobile electronic device 12 is retained within the housing 14.

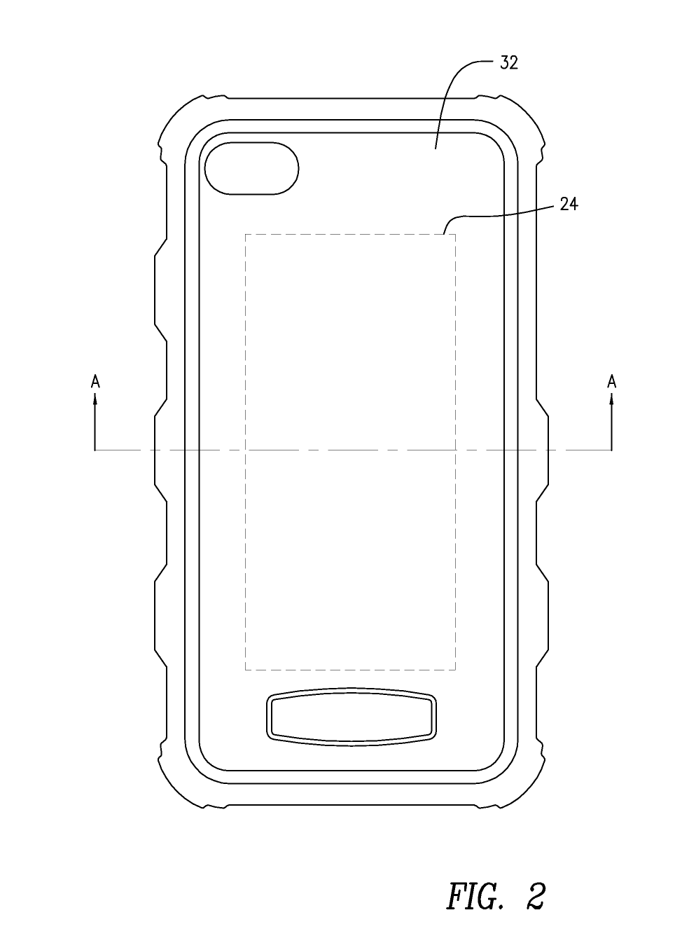

Referring now to FIGS. 2 and 3, the housing 14 includes an inductive charging signal repeater 24 disposed within at least a portion of the housing 14. The inductive charging signal repeater 24 may comply with the Qi standard for inductive charging, or alternatively, any resonant charging frequency. In an exemplary configuration, the inductive charging signal repeater is Qi compliant and is configured to receive a Qi compliant inductive charging signal 26 transmitted from an inductive charging pad 28. The inductive charging pad 28 may be in communication with a power source, for example, an alternating current source, and may be any shape or size. In an exemplary method of use, the housing 14 retaining the mobile electronic device 12 rests on top of the charging pad 28 such that the back portion 20 is in contact with the charging pad 28. The inductive charging signal repeater 24 disposed within the housing 14 may receive the inductive charging signal 26 and passively or actively transmit the received inductive charging signal 26 such that it can be received by the mobile electronic device 12 when retained within the housing 14 as discussed in more detail below.

The inductive charging signal repeater 24 may be molded to or disposed within any portion of the housing 14 and may be any shape or size sufficient to be molded within or to the housing 14. In configurations in which the housing 14 is a unitary configuration, the inductive charging signal repeater 24 may be partially or entirely molded within the back portion 20 of the housing 12 such that it is partially or entirely concealed within the housing 14. The inductive charging signal repeater 24 may further be sized such that the overall profile, i.e. height, width, and length of the housing 14 remains unchanged by the additional of the inductive charging signal repeater 24. For example, the inductive charging signal repeater 24 may be employed using circuitry on a thin substrate extending longitudinally within an interior or exterior portion of the back portion 20. In particular, the back portion 20 may define a recess (not shown) sized to receive the signal repeater 24. In other configurations, the inductive charging signal repeater may be adhered to the housing 14 by an adhesive, such as glue, and may be permanently or removeably affixed to the housing 14. For example, the inductive charging signal repeater 24 may be glued or otherwise adhered to the interior surface 30 or the exterior surface 32 of the back portion 20. In configurations in which the housing 14 is a multi-piece case 10, the inductive charging signal repeater 24 may be molded to or which the first portion 16 and may be adhered to the first portion 16 in the same manner as that of unitary housing 14 configurations. As further discussed below, the distance “d” represents the distance between the inductive charging signal transmitter in the charging pad 28 and the inductive charging signal repeater 24; “y” is the thickness of the inductive charging signal repeater 24; “x” is the distance between the interior surface 30 of the housing 14 and an inductive charging antenna 33 of the mobile electronic device 12; and “z” is the distance from inside the inductive charging signal repeater 24 to the interior surface 30 of the housing 14.

In particular, the inclusion of the inductive charging signal repeater 24 functions increase the maximum distance by which the charging antenna within the mobile electronic device 12 can be charged by a Qi compliant inductive charging signal transmitted by the charging pad 28. For example, if no inductive charging signal repeater 24 is included, then the maximum distance between the charging antenna 33 inside the mobile electronic device 12 and the inductive charging antenna inside the charging pad 28 is 5 mm. However, with inductive charging signal repeater 24, when the inductive charging signal 26 travels 5 mm to the inductive charging signal repeater 24, the inductive charging signal 26 is repeated or amplified, as the case may be, allowing the mobile electronic device 12 to be charged when disposed within the housing 14. Thus, in this case, the inductive charging signal repeater 24 increases the maximum distance by which the mobile electronic device 12 may be charged by an inductive charging signal 26 beyond 5 mm, e.g., to at least 10 mm or more. In particular, the charging antenna 33 inside the mobile electronic device 12 may be charged if “d” is less than or equal to 5 mm and if “z+x” is less than 5 mm, as losses in the inductive charging signal 26 strength may occur. It is further contemplated that the housing 14 may include an adaptor (not shown) or other connector that includes the inductive charging signal repeater 24 and that extends a distance away from the housing 14. For example, the adaptor may extend away from the back portion 20 such that the maximum distance by which the mobile electronic device 12 may be charged by an inductive charging signal 26 may be increased.

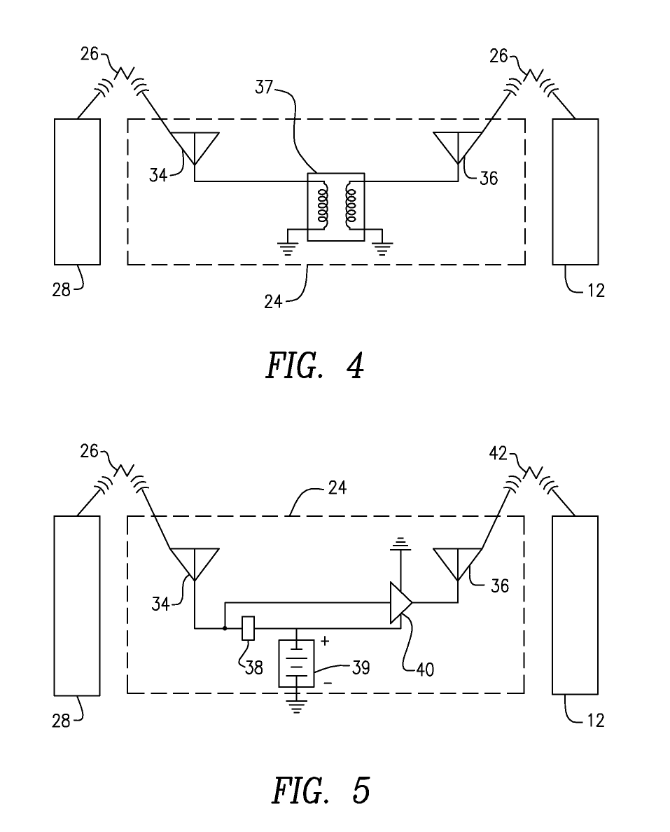

Referring now to FIG. 4, the inductive charging signal repeater 24 may be configured to passively receive and transmit the inductive charging signal 26 from the charging pad 28. In particular, because the inductive charging signal repeater 24 is molded or otherwise adhered to the back portion 20 such that a first signal antenna 34 of the inductive charging signal repeater 24 is within the predetermined distance to receive a Qi compliant signal, for example, 5 mm, the inductive charging signal repeater 24 may receive the inductive charging signal 26 from the charging pad 28. In configurations in which the inductive charging signal repeater 26 is passive, the inductive charging signal repeater 26 includes the first antenna 34 configured to receive the inductive charging signal 26 and a second antenna 36 configured to transmit the inductive charging signal 26 toward the mobile electronic device 12 that charges the battery of the mobile electronic device 12. A coil 37 or other electromagnetic energy creation structure may be disposed between the first antenna 34 and the second antenna 36 such that the energy received from the first antenna 34, less the inherent losses in the repeater circuit, is transmitted by the second antenna 36. The coil 37 is only shown in the drawings for ease of understanding. It is contemplated that additional electronic components may be implemented with the inductive repeater 24 to perform the repeating functions described herein. For example, in another configuration, the coil 37 itself as a single element is not included and instead the printed circuit board supports a conditioning circuit to condition the voltage, current, and frequency of the inductive charging signal 26 as the signal propagates from the first antenna 34 to the second antenna 36. It is contemplated that one of ordinary skill could design a suitable conditioning circuit. In other words, in this embodiment, a conditioning circuit is electrically coupled between the first antenna 34 and the second antenna 36, in which the conditioning circuit is configured to receive an inductive charging signal 26 from the first antenna 34, electrically condition the received inductive charging signal 26 and transmit the electrically conditioned inductive charging signal 26 to the second antenna 36.

Referring now to FIG. 5, in configurations in which the inductive charging signal repeater 24 is an active signal repeater, the inductive charging signal repeater 24 may include the first antenna 34 configured to receive the inductive charging signal 26. The first antenna 34 may be communication with a rectifier 38 configured to convert alternating current into direct current. A battery 39 may be included and in communication the rectifier 38 such that the battery 39 is charged by the rectified inductive charging signal 26. The battery 39 may further be in communication with an amplifier 40 which is powered by the battery 39. Methods for inductively charging of a battery, in generally, are known in the art and beyond the scope of this disclosure. The amplifier 40 may be in further communication with the second antenna 36, which is configured to transmit an amplified inductive charging signal 42 generated by the amplifier 40 and/or generate and transmit its own Qi complaint inductive charging signal from the housing 12 toward the mobile electronic device 12 as discussed in more detail below. The amplified inductive charging signal 42 allows for the use of a thicker case 10 because the attenuation effects of the case may be mitigated. For example, an outer silicone gel (not shown) may be wrapped around the exterior of the case 10 for added protection without effecting the ability to inductively charge the mobile electronic device 12.

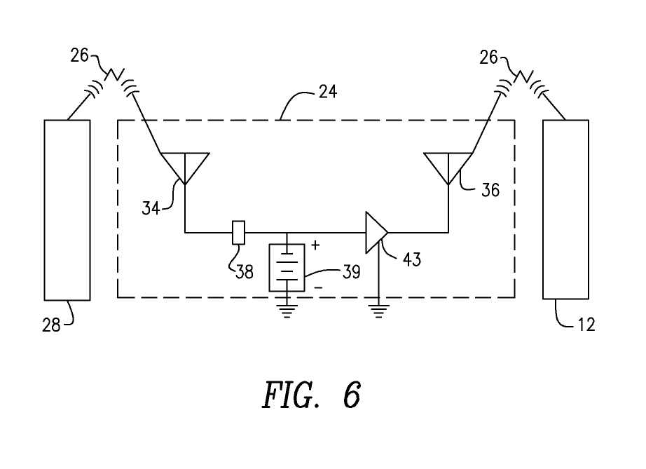

Referring now to FIG. 6, in another configuration, the battery 39 may be charged by the inductive charging signal 26 and may provide power directly to a signal generator 43, such as a Qi compliant signal generator 43, which is in communication with the antenna 36 to generate the inductive charging signal 26 from the signal repeater 24. For example, the battery 39 may store a charge received from the inductive charging signal 26, which is received from the charging pad 28. When the user carries the case 10 away from the charging pad, the user can activate the signal repeater 24 such that the battery 39 provides power to the Qi inductive charging signal generator 43, which transmits the inductive charging signal to the second antenna 36 to transmit the inductive changing signal 26 that charges the electronic device 12 when the electronic device is retained within the case 10. A switch (not shown) may be included in the case 10 to switch on the circuit that provides power from the battery 39 to the signal generator 43 to generate the inductive charging signal 26. Thus, when the case 10 with the electronic device 12 retained within is placed in proximity to the charging pad 28, the battery 39 may be charged by the inductive charging signal 26 as well as the inductive charging signal 26 providing power from the battery 39 to charge the mobile electronic device 12 when the mobile electronic device is moved away from the Qi inductive charging signal generator 43.

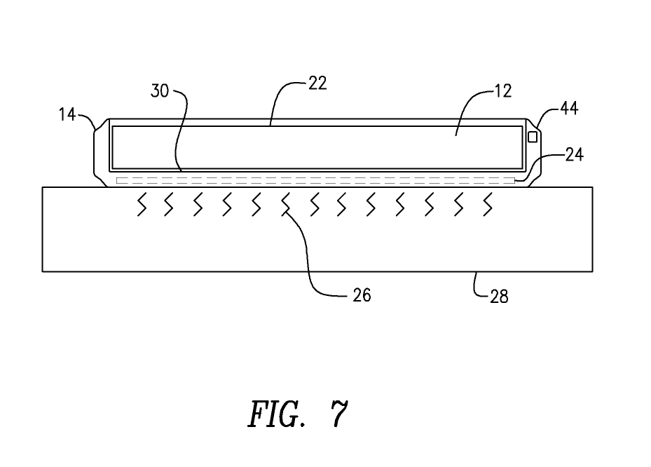

Referring now to FIG. 7, an indicator 44 may be included on or within the housing 14 to indicate whether the inductive charging signal repeater 24 receives and/or transmits the inductive charging signal 26 toward the mobile electronic device 12. The indicator 44 may be a visual and/or audio indicator, for example, either a flashing or constant light or a beep or some other sound. Thus, in the event that a Qi compliant phone is not charging when retained within the housing 14, the indicator 44 may provide the user with information whether the mobile electronic device is malfunctioning or the inductive charging signal repeater 24 is not operating within normal parameters.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope of the invention, which is limited only by the following claims.

What is claimed is:

1. A mobile electronic device case, comprising:
a housing sized to releasably retain a mobile electronic device; and
an inductive charging signal repeater disposed within the housing.

2. The case of claim 1, wherein the housing includes a power source in communication with the inductive charging signal repeater, and wherein the power source is configured to be charged by an inductive charging device, and wherein the power source provides power to the inductive charging signal repeater.

3. The case of claim 2, wherein the inductive charging signal repeater is configured to amplify and transmit an inductive charging signal received from the inductive charging device.

4. The case of claim 2, wherein the power source is configured to receive an inductive charging signal from the inductive charging signal repeater, and wherein the inductive charging signal repeater is configured to increase a maximum distance by which the power source receives the inductive charging signal sufficient to charge the mobile electronic device.

5. The case of claim 1, wherein the inductive charging signal repeater is a passive signal repeater.

6. The case of claim 1, wherein the inductive charging signal repeater is molded to the housing.

7. The case of claim 1, wherein the housing includes a first portion removeably coupled to a second portion, and wherein the first portion is configured to receive the mobile electronic device, and wherein the inductive charging signal repeater is disposed within the first portion.

8. The case of claim 1, wherein the inductive charging signal repeater is entirely concealed within the housing.

9. The case of claim 1, wherein the inductive charging signal repeater is configured to receive a first inductive charging signal from an inductive charging device, and wherein the inductive charging signal repeater includes a power source configured to be charged by the inductive charging signal, and wherein the inductive charging signal repeater is configured to generate and transmit a second inductive charging signal.

10. The case of claim 1, further including a battery and an amplifier disposed within the housing, and further including at least one antenna in communication with the battery, the battery configured to provide power to the amplifier, the amplifier in communication with the at least one antenna and configured to create an inductive charging signal for transmission by the at least one antenna.

11. The case of claim 1, wherein the housing includes an indicator in communication with the inductive charging signal repeater configured to indicate when an inductive charging signal is being transmitted by the inductive charging signal repeater.

12. A mobile electronic device case, comprising:
a housing sized to releasably retain a mobile electronic device; and
an inductive charging signal repeater releasably engageable to a portion of the housing.

13. The case of claim 12, wherein the inductive charging signal repeater is removeably adhered to a portion of the housing.

14. The case of claim 13, wherein the housing includes a back portion, and wherein the inductive charging signal repeater is removeably adhered to the back portion.

15. The case of claim 12, wherein the housing includes a power source in communication with the inductive charging signal repeater, and wherein the power source is configured to be charged by an inductive charging device, and wherein the power source provides power to the inductive charging signal repeater.

16. The case of claim 15, wherein the inductive charging signal repeater is configured to amplify and transmit an inductive charging signal received from the inductive charging device.

17. The case of claim 12, wherein the inductive charging signal repeater includes:
a first antenna;
a second antenna; and
a conditioning circuit electrically coupled between the first antenna and the second antenna, the conditioning circuit configured to receive an inductive charging signal from the first antenna, electrically condition the received inductive charging signal and transmit the electrically conditioned inductive charging signal to the second antenna.

18. The case of claim 17, wherein the mobile electronic device receives an inductive charging signal from the inductive charging signal repeater, and wherein the inductive charging signal repeater is configured to increase a maximum distance by which the mobile electronic device receives the inductive charging signal sufficient to charge the mobile electronic device.

19. The case of claim 12, wherein the inductive charging signal repeater is configured to charge the mobile electronic device when the housing is placed in contact with an inductive charging device.

20. A mobile electronic device case, comprising:
a housing sized to releasably retain a mobile electronic device, the housing including a back portion; and
an passive inductive charging signal repeater molded within the back portion of the housing, the inductive charging signal repeater being entirely concealed within the back portion and configured to charge the mobile electronic device when the housing is placed in contact with an inductive charging device.
